(19) United States
(12) Patent Application Publication
(10) Pub. No.: US 2017/0240041 A1
(43) Pub. Date: Aug. 24, 2017

(54) Crawl speed lawnmower operable using solar energy as sole power source

(71) Applicant: Chiou-muh Jong, Ellicott City, MD (US)

(72) Inventor: Chiou-muh Jong, Ellicott City, MD (US)

(21) Appl. No.: 14/881,118

(22) Filed: Oct. 12, 2015

(51) Int. Cl. B60K 16/00; A01D 34/00; A01D 34/78

(52) U.S. Cl. CPC B60K 16/00; A01D 34/78; A01D 34/008; A01D 2101/00

(57) ABSTRACT

A substantially slow moving lawnmower capable of slowly mowing a lawn solely depends on the sun power is presented. The lawnmower needs no recharging from any other power source. A small battery is used to regulate the unsteady sun power so that normal mowing operation can be continued for a specific time period depends on the capacity of the battery. The lawnmower operates by itself continuously with least human interruption.

### CROSS-REFERENCES TO RELATED APPLICATIONS

This non-provisional utility application was filed within one year of and claims a domestic priority date of Oct. 22, 2014 based on U.S. provisional application No. 62/067,376, filed Oct. 22,2014.

### FIELD OF THE INVENTION

The present invention relates to a self operated, slowly moving lawnmower with the goal to use minimum energy such that the sun power in a reasonable sunny day will be enough to power lawnmower operation, albeit very slowly. In fact, current invention proposes to use much longer time (say, 4 hours versus 40 minutes) to complete the mowing operation for any specific lawn area as compared to using typical high power lawnmowers, in exchange for being able to use low power such as solar power generated by the solar panel with the size in the same order as that of the lawnmower. More specifically, it is a lawn mower operating at a very slow moving speed as compared to other commercially available lawn cutting machines in order to reduce machine cost by using relatively cheap small battery used not for providing power, but for maintaining steady power supply, and by elimination the need to use AC power charge the big, expensive battery.

### BACKGROUND OF THE INVENTION

A big lawn looks beautiful, yet with a big price to pay in behind—noisy lawn mowers in operation too often interrupt our morning dream and make our tranquil village more noisy than the traffic bring to us. Quiet machines are highly desirable to replace those noise gas engine mowers, not to mention the pollution bring to air by the two cycle engines.

There are many quiet machines running on electric motor available on the market. However, they are still not main stream machines despite they use much more quiet electric motors to power these lawn mowers. The reason behind is that, at present, commonly used lawn mowers are designed to be very powerful in order to shorten the mowing time as much as possible and as a consequence the fast moving lawn mowers of electric version need a big battery pack to provide enough electricity for a cutting a typical size of lawn. Big battery pack means expensive initial investment and maintenance cost and it makes the machine unreasonably bulky too.

In fact, if the lawn mower is self guided with very little human interruption, it would be possible to design a slow moving machine with minimum power requirement. Why the lawn needs to be mowed in a short time such as one or two hours, not a whole day long? It is because those machines are mostly operated by humans and most of them cannot tolerate long mowing time. Imagine a wide open lawn in a golf course or in the park where a slow moving lawn mower completely powered by the sunshine, who cares how long it takes? One day? Two days? The shortest mowing cycle period for a typical lawn is around 4 days to one week long. So as long as the machine can complete mowing in a cycle period, it would be just fine.

So here the solution is to present a slow moving, self guided and directly solar powered lawn mower according to current invention. Such lawnmower takes much longer time to mow in exchange for minimum power consumption—thus makes it directly powered by solar energy possible, instead of the strategy of “storing the solar power into battery first and mowing lawn later”.

Due to the advance of solar panel technology, solar energy is used more and more daily life tasks and apparently using it for cutting grass is one of them. For example, the patent U.S. Pat. No. 4,924,733 proposed to use solar power for lawnmower. Understandably, it should be one of the earliest ideas to use solar energy for cutting grass. However, the solar energy is not used to drive motors for the cutting and movement. Instead, it is used to charge the battery and battery power in turn is used to operate the lawnmower. Such design in general needs a big battery pack stored with enough electric energy for a meaningful operation time.

U.S. Pat. No. 5,323593 also proposed the use of solar power for indirect power source—as did in many other designs, storing solar energy into the battery and use it later as it intends to mow the lawn in regular pace—a pace equals to human walking or faster like the riding lawnmower. U.S. Pat. No. 5,906,088 is another example of using solar power to charge a battery operated lawnmower designed in similar mowing pace.

China Patent CN101861781 is a design of battery operated lawnmower having more sophisticated control unit for selection of various level of operations. Commercially, some robot lawnmower designs are already available on the market. Their common features are: all of them are battery operated and controlled mostly by sensor detection to maintain operation within a specific area, and their battery need to be recharged at special designed charging station powered by AC power source extended from homes or other facilities. Another feature is that they are expensive to make, so the retailed price is typically out of touch by most home owners.

Patent EP055043 discloses a lawnmower designed to continuously operate as a self guidance mowing machine based on “waiting or mowing” strategy, i.e. waiting to mow during charging period and mowing when battery exhausted. This design, despite it is the continuous working machine, it needs a big battery to conduct a mowing operation in fast pace as most lawnmowers do. It cannot use very small power such as direct solar power to mow the lawn.

Robot lawnmowers are in the market for nearly two decades long, but they are, in general, very expensive for most lawn owners to own ones. The real factor to make it expensive is the requirement of fast pace in mowing operation, which is really not a necessary condition for a practical lawnmower to have. On the contrary, it makes the lawnmower demanding big power to operate and the control logic for obstacle avoidance becomes complex and expensive, in addition to the expensive battery and the AC charging station to suffice autonomous mowing operation.

### SUMMARY OF THE INVENTION

A lawnmower totally depends directly on sun power is invented. The sun power is used directly to drive the operation of mowing, instead of charging to battery for later use. By allowing very slow moving speed, the lawnmower uses minimum energy to operate and hence a good portion of sun power in sunny day time is available for driving the lawnmower to finish mowing a specific area of a lawn. Such lawnmower is designed to be continuously used whenever there the sunshine is available to operate the machine, the lawn will mostly be cut before it grows long, therefore maintaining the lawn in good condition.

A very affordable battery of small capacity is used to regulate the unsteady nature of sun power. The battery absorbs excess energy from solar panel and releases energy when sun power alone is not enough to drive mowing operation.

It is therefore a primary object of current invention to provide a lawnmower which consumes so little power that it can fully operate solely on the sun power under reasonably bright sunny day.

Another object is to create a robot lawnmower which needs least human interruption during the lawn mowing operation.

Yet another object is to make the lawnmower realized by current invention frees from the need to charge battery off site, consequently frees from setting up any, especially AC charging station, which constitutes complex control logic and more importantly, increases the manufacturing cost of robot lawnmower dramatically.

Still another object of current invention is to lower the cost to build a robot lawnmower by eliminating the need to use high cost battery pack as the major initial and maintenance cost for the lawnmower.

One more object current invention has is to implement a robot lawnmower with very slow moving speed such that the functions of navigation control and obstacle avoidance are much easier to achieve, as compared to robot lawnmower moving in the neighborhood of human walking speed. In particular, it is easy to see that such slow moving machine is much safer to operate, because the response time before collision is longer; consequently it is a safer robot lawnmower for every owner to have.

Another object is that, through the implementation of current invention, a lawnmower can mow the lawn whenever sun power is enough for doing so, thus keeping the lawn in good cut-short condition almost all the time.

One more object of current invention is to reduce cost of maintaining a beautiful lawn to minimum—fulfilling the philosophy of “Sun grows, sun cuts”.

### BRIEF DESCRIPTION OF DRAWINGS

In the drawings, FIG. 1 shows an example implementation of current invention. It briefly shows most major components such as frame, supporting wheels, cutting assembly, motors and solar panel for performing slow mowing operation.

FIG. 2 shows the illustration of an increment of cutting area by the progressing of cutting assembly in time increment of Δt. In this time increment, the lawnmower moves a distance Δd, which is apparently a function of lawnmower moving speed.

FIG. 3 illustrates the circuit connection from the solar panel to battery and from battery to all motors and other power consumption by the lawnmower.

### DETAILED DESCRIPTION OF DRAWINGS

Illustrated in FIG. 1 is the lawnmower 100, a preferred implementation of current invention, which further contains major components from 101 to 109. To support the lawnmower, front wheel assembly 101 and rear wheel assembly 102 are used. In this particular implementation, rear wheels are driven by a motor 109, whose operation is controlled by the central controller 105. Front wheel assembly 101 has a motor driven steering mechanism 107, which is also controlled by the central controller 105 for the moving direction. Total number of wheels of the lawnmower can easily be designed to have either four or three. In the case when only three wheels are used, either front or rear wheel assembly is a one wheel assembly. Also, in other implementations, driving wheel assembly can either be front or rear.

Grass cutting assembly 103 and driving motor 106 constitute the primary components for the function of the lawnmower. The assembly can be a single blade or have a combination of several blades—like some of currently available fast moving robot lawnmower. For the implementation of current invention, single blade cutting assembly is the preferable choice because of the slowness of the moving speed.

Component 104 is the solar panel, which provides the sole power for the operation of lawnmower implemented by current invention. More discussion will be presented regarding to the size of solar panel to provide sufficient power in the later session.

Battery 108 is a battery with capacity just enough to provide the mowing operation for a short time period, say, 10 minutes or so. The major function of this battery is not for driving the operation of the lawnmower. Instead, it is used to regulate the unsteady solar power, store excess energy during operation, or provide additional power when solar panel alone does not generate enough power to have normal operation, which typically happens when clouds move in suddenly to block portion of sun power, or the lawnmower moves into a shady area. Of course, such condition is not expected to last long. In case it is, the lawnmower just stops operation when the battery does not have enough power to assistant a normal operation and solar panel will charge the battery when the solar panel still generates small current to charge it. It is worthy of noting that, since the lawnmower only need small amount of energy to operate, a small battery such as a 12 volt one with capacity of 2.0 ampere-hours will provide enough power to operate for some time period and to this purpose, any cheap, small lead acid battery can fulfill the battery requirement for the lawnmower implemented under current invention. More analysis about the capacity of the battery will be discussed in later session.

Central control unit 105 is responsible for the control of all activities of lawnmower 100, includes the guidance of it inside a predetermined boundary based on data transmitted from detecting sensors, the decision to operate or stop based on the power level comes from solar panel and the energy of battery. In addition, it also controls the cutting path to encircle obstacles such as trees, bushes on the way. To get more accurate data for the lawnmower's location, a GPS channel can be used obtain location data for obstacle avoidance. Central control unit has communication to all the motors used in the lawnmower in order to execute the command to stop, move and turn to a new direction.

The logic of central control unit for starting and stopping the mowing operation is to be programmed as following:
1) Controller is set to standby mode between a specific time in the morning and a specific time in the afternoon
2) Mowing operation is allowed only in standby mode
3) Start operation in standby mode when solar panel provides a power level exceed a predetermined threshold
4) In standby mode, mowing operation continues if battery's power level is sufficient for the operation or when sun power is above threshold
5) Charging to the battery is allowed whenever solar panel delivers power to do so

Basically, the central controller is programmed to initiate the mowing operation when the solar power exceed the power it needs to operate and to stop the operation when solar power is weak and battery level is low. Knowing that sun shine is available only in a certain period of day time, a standby mode can be set to simplify the logic for controlling the operation.

On the daily basis, available sun light intensity, as we all know, changes all day long, so we need to have a threshold value regarding to the sun power which is strong enough to activate normal operation of the lawnmower. Furthermore, the angle of incident on solar panel varies from season to season too. Fortunately, the phase changes of incident ray strength and angle are roughly coincident with the phase change of the need for mowing the lawn; the sun power actually peaks in the hot summer when we need to cut the grass most. All these factors needed to be considered when we set the threshold to start the mowing operation. Of course, a solar panel big enough to provide sufficient power in a non-peak condition is the most crucial factor to be satisfied.

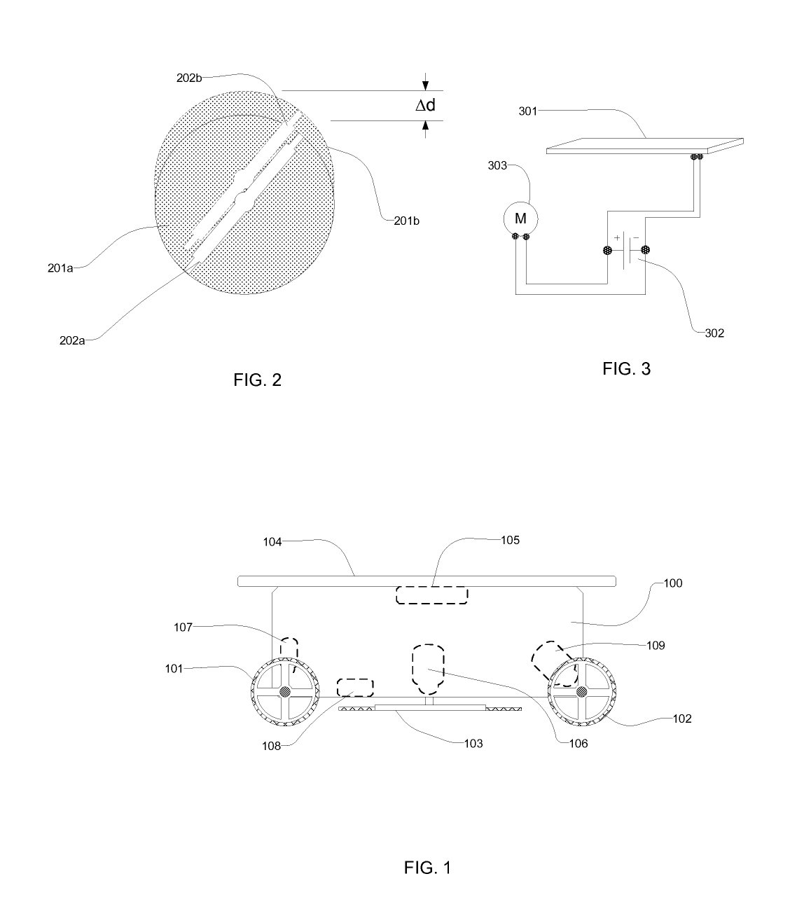

FIG. 2 illustrates the differential cutting area when the blade 202 in cutting assembly 103 rotates one revolution in a time interval of Δt. In that interval, the center of cutting assembly 103 moves a distance of Δd, which means that the position of blade 202a at time t moves to position 202b at time t+Δt as shown in the figure. Also shown there is the cutting area 201a by blade 202a at time t and 201b by 202b at time t+Δt. As can be understood, Δt is the inverse of the rotational speed of the cutting assembly. If we use n rps (revolution per second) to represent the rotational speed, Δt will be 1/n (60/n in case rpm is used) seconds, i.e., it needs 1/n seconds to make one revolution (2π rad). For a given electric lawnmower, n is typically a constant depends on the dc motor speed divided by the gear reduction ratio. However, it is usually thought that the higher the speed of rotation is, the cleaner it cuts the grass, so it is not unusual to see rotational speed higher than 3,000 rpm is used in a robot lawnmower. Thinking n as a constant, the energy required to cut an area corresponding to distance of Δd then depends only on the moving speed of the lawnmower. It is very easy to understand that, if the moving speed is zero, then all the energy the cutting blade needs to maintain n rpm is the friction loss LS of the mechanism, which is typically very small amount as compared to the energy required to cut the grass.

Therefore, as the lawnmower moving speed S approaches to zero, the total energy required will be approaching to the amount of friction loss LS. In practice, this is a very small number; even a 5 watt or smaller power dc motor will be more than able to maintain n rpm when the lawnmower is standing still. This means that, the total power needs to operate the lawnmower very much depends on the moving speed S. In practice, the reduction gearbox output at 6 rpm of a 3,100 rpm dc motor with output of 25 watts is more than enough to drive the speed of a lawnmower prototype weighing about 80 lbs (includes solar panel) with wheel diameter of 12″ to a speed S approximately equals to 0.33 feet/sec. At this speed, it takes 10 minutes to finish a trip of 200 feet long. This means that, if the cutting path is 36″ wide, it will need roughly 360 minutes, or 6 hours to cut a half an acre lawn, as compared to about 20 minutes by a riding lawnmower to do the same mowing. However, this data is very conservative because it uses a commercial solar panel with efficiency of mere 10% and it outputs less than 60 watts at the best sunshine condition, although the product claims its rated output is 100 watts. Better efficiency definitely will increase the power output for the same size solar panel.

For higher efficiency solar panels which deliver more than 60 watts at peak output, a moving speed S higher than 0.33 feet per second is definitely possible. Typical human walking speed is roughly 3 feet/sec, which is almost ten times as fast as the experiment speed, which we now know is slow enough for a solar panel output 50 watts to maintain mowing operation. But to know how much higher it is still acceptable, we need more experiments using other combinations of more efficient solar panel and cutting assembly to get more favorable speed value. In fact, it depends on the efficiency of the cutting blade and solar panel, the average strength of intensity of sunshine in the whole lawn mowing season, average incident angle during that period and so on. Very possible a little higher value than 0.33 ft/sec, say, 0.5 ft/sec is even more ideal because it is a speed still substantially lower than human walking speed (and hence the moving speed of push lawnmower) but it drops the time needs to mow from 6 hours for a half acre lawn to 4 hours, a big 50% reduction one cannot ignore! From practical view point, 4 hours cycle time makes it much more flexible because it is almost definite to have 4 hours sun power available for such lawnmower to complete one cycle in three days and this means that two complete mowing cycles at least in one week—this can easily satisfy the goal of current invention to come out a lawnmower which will keep lawn mowed all year long relying solely on solar energy.

Do we have six hour sunshine a day for the lawnmower? Very possibly it is not. However, two days will be highly possible. Does it make difference if we mow a half acre lawn between 20 minutes and two days? Maybe, but it is not in the sense that the lawnmower needs no interruption from human. In fact, except in the very special case of several contiguous days without good sunshine in late spring when grass grow very fast, a design based on finishing cutting every two days is very close to what we need for the lawnmower for yearlong use because we can either artificially charge the lawnmower during that special period should such very special situation happens. However, may be a larger battery for storing more energy, or increase the solar panel size to cover such special case is a better solution. Anyway, no design can cover all exceptions. The lawnmower based on current invention is certainly true in this regard.

It is obviously that the design of such a lawnmower is essentially an optimal design problem. Specifically, we want to design a lawnmower implemented by current invention such that it optimize a function constituted by the manufacturing of the cost and the moving speed of the lawnmower, subjected to the constraint of limited average sun power annually (from limited size of solar panel and change in season) and average shady area ratio for the potential customers. In details, if C_{f} represents the cost function to be minimized and S_{f} is the speed to be maximized, then we want to optimize the object function O (p₁, p₂, p₃ . . . )

O(p₁, p₂, p₃ . . . )=S_{f}(p₁, p₂, p₃ . . . )−λC_{f}(p₁, p₂, p₃ . . . )

subjected to the constraints

ASP(location, season)<=const

ASAR(location, time)>=constant

where λis the weighting parameter, and p₁, p₂, and p₃ are variables of the object function such as motor power, size of solar panel, component cost of each major item constitutes the lawnmower and ASP is the average sun power, ASAR is average shady area ratio.

The optimization of object function in this case is to find the minimum value of C_{f} and the maximum value of function S_{f} and it is essentially the same as finding the maximum value of S_{f}+(−λC_{f}), or simply S_{f}−πC_{f}.

It is worthy of noting that if a solar panel of rectangular shape is to be used for a particular lawnmower, the width W of solar panel, for the sake of making it as big as possible for a lawnmower to be designed, is closely related to the width of cutting path by linear relationship. In other words, the width W is usually set to a little wider than the width of cutting path in order to make the size as big as possible, and roughly it is in proportion to the width of cutting path. The relatively fixed value of W of solar panel consequently leaves the required solar power, and hence the required solar panel size depends mostly on the length L of the solar panel. That is to say, when the cutting path is decided in the design process, the width of solar panel is also determined. The size and consequently the power of solar panel at this stage is pretty much depends on the length of solar panel, which in turn also determines the moving speed of the machine.

Although it is hard to derive the exact close form for the object function and will probably not worth to do so, it is still mentioned in previous paragraph to emphasize that this is really a typical engineering optimization problem. Such optimization problems, when we have object function and the constraint equations, typically are solved using the method of calculus of variation. Once they are solved, we can see the special meaning of λ, which is the characteristic value of the problem solved. For the case here, it will corresponding to several of available values such as λ₁, λ₂ and so on. Physical meanings of these values are the ratios of cost C_{f} and S_{f} where object function reaches local maximum.

FIG. 3 shows the circuit connection in which solar panel 301 channels the current it generates to battery 302 while the same two terminals of 302 also connect to all loads such as motors 303. At peak solar power generation condition, the solar panel generates more power than needed to maintain the normal operation of the lawnmower, so the battery serves at such condition as the energy reservoir to store excess solar energy. When the cloud moves in and the power supply from solar panel is not enough to run the lawnmower, the battery will deliver the necessary power to maintain mowing operation. It is easy to understand that the battery capacity will determine how long it can support the normal operation—10 minutes, 20 minutes or even longer. However, keep in mind that unsteady solar power is the major power source in current invention; batteries of overly big capacity are not what we intend to install. Not only high capacity batteries are expensive, it also true that with the rationale of current invention, such high capacity batteries will never get fully used unless the mowing operation is artificially suspended for changing the battery—and this definitely is not what we want to see.

The unsteady characteristic of solar power makes it necessary to have a battery for regulating the power. What percentage of the operation will need the assistance of battery is the key to determine the capacity to be used. If a lawn is mostly lies in the shady area, then there is no chance to mow such lawn using a lawnmower which uses solar energy as the instant power source, although a lawnmower with big battery charged by solar panel before being operated is doable. So the capacity of a battery to install in a lawnmower according to current invention is again an optimization problem: optimizing required battery capacity with key factors such as battery cost, average year round solar energy availability and average shady area ratio etc. such that the lawnmower can be used as many lawns as possible, yet is still cost effective to be used.

For some open lawn spaces such as fairways in golf courses, the lawnmowers implemented according to current invention are of especially helpful for reducing the mowing cost. In such mowing operation, much wider lawnmowers with much wider cutting path are needed. To be more flexible for such scenario, the lawnmower can be designed in module structure such that a number of them can be combined to satisfy a specific width of cutting path as customization for individual golf course or other specific open area to be mowed.

To optimize the area of solar panel, four smaller pieces of solar panels can be installed at the edges of the four sides of the major panel with angle of 45 degree to vertical plane. This will increase the area if the height of these smaller solar panels does not cause them blocking the major panel from receiving sun light.

The embodiments presented above are typical implementation of current invention. Various modifications can be made without departing from the scope of current invention, which is defined in attached claims. For example, the number of solar panels cans easily more than one. Solar power can be used to create hydrogen for a fuel battery to operate the lawnmower.

I claim:

1. A lawnmower using unsteady power source as major operation power and moving at a substantially slow speed in regular mowing operation for minimum energy consumption, the lawnmower comprising:
a set of motor driven grass cutting assembly,
a solar panel for providing sufficient power at sunny condition for the propulsion of the lawnmower and for mowing the lawn at a substantially low moving speed,
a battery for regulating unsteady solar power and storing excess electric energy,
a frame for securely holding said grass cutting assembly, said solar panel and a plurality of supporting motor driven wheels, whereby said lawnmower can mow the lawn automatically using the unsteady power provided by said solar panel under the typical sunny weather.

2. The lawnmower according claim 1 further comprising a control means for guiding the movement of said lawnmower inside a predetermined boundary and for obstacle avoidance.

3. The lawnmower according to claim 1, wherein the size of said solar panel is determined by the minimum required energy for the propulsion of the lawnmower and the energy required by said grass cutting assembly, and is further determined by the width of cutting path, moving speed of the lawnmower and the height of grass to be cut.

4. The lawnmower according to claim 1, wherein said battery is used as a regulator to accept unsteady electric power from said solar panel, output steady electric power for the operation of the lawnmower and store excess energy when the said solar power delivers more power than required by the operation of the lawnmower.

5. A method for providing a lawnmower using unsteady power source as major operation power and moving at a substantially slow speed in regular mowing operation for minimum energy consumption, the method comprising the steps of:
providing a set of motor driven grass cutting assembly,
providing a solar panel for sufficient power at sunny condition for the propulsion of the lawnmower and for mowing the lawn at a substantially low moving speed,
providing a battery for regulating unsteady solar power and storing excess electric energy,
providing a frame,
installing and securely holding said grass cutting assembly, said solar panel and a plurality of supporting motor driven wheels, whereby said lawnmower can mow the lawn automatically using the unsteady power provided by said solar panel under the typical sunny weather.
